(19) United States
(12) Patent Application Publication
(10) Pub. No.: US 2019/0072004 A1
(43) Pub. Date: Mar. 7, 2019

(54) Casing Of A Turbocharger And Turbocharger

(71) Applicant: MAN ENERGY SOLUTIONS SE, Augsburg (DE)

(72) Inventors: Steffen BRAUN, Augsburg (DE); Urban Spatz, Neusaess (DE)

(73) Assignee: MAN ENERGY SOLUTIONS SE

(21) Appl. No.: 16/122,055

(22) Filed: Sep. 5, 2018

(30) Foreign Application Priority Data
Sep. 5, 2017 (DE) 102017215591.4

(51) Int. Cl. F01D 25/26; F01D 25/08; F01D 25/24; F02C 6/12

(52) U.S. Cl. CPC F01D 25/26; F01D 25/08; F05D 2220/40; F02C 6/12; F01D 25/243

(57) ABSTRACT

A casing of a turbocharger, which surrounds the turbocharger radially and axially outside at least in sections. The casing has multiple casing modules including a temperature casing module that surrounds the turbine, the compressor, and/or the bearing housing radially outside and axially outside at least in sections, an inner burst protection casing module following the temperature casing module on the outside, and at least one outer burst protection casing module following the inner burst protection casing module on the outside, which surrounds the inner burst protection casing module.

### BACKGROUND OF THE INVENTION

### 1. Field of the Invention

The invention relates to a casing of a turbocharger and to a turbocharger.

### 2. Description of the Related Art

The fundamental construction of a turbocharger is known to the person skilled in the art addressed here. A turbocharger comprises a turbine in which a first medium is expanded, a compressor in which a second medium is compressed, namely utilising the energy extracted in the turbine during the expansion of the first medium, having a turbine housing and a turbine rotor. The compressor comprises a compressor housing and a compressor rotor. Between the turbine housing of the turbine and the compressor housing of the compressor a bearing housing is positioned. The bearing housing is connected on the one side to the turbine housing and on the other side to the compressor housing. In the bearing housing, a shaft is mounted via which the turbine rotor is coupled to the compressor rotor.

During the operation of a turbocharger there is the risk that a rotor, for example the turbine rotor or the compressor rotor of the turbocharger breaks and fragments of the rotor strike through the relevant housing, i.e. the turbine housing or the compressor housing. This then poses the risk that the fragments of the turbocharger enter the surroundings. In order to take into account this problem of the bursting of a rotor of the turbocharger, the respective housing in turbochargers known from practice is designed in such a manner that a failure of the respective housing need not be expected and even in the event that the respective rotor should break, fragments of the same cannot strike through the respective housing. However, the weight of the turbocharger is increased because of this.

In order to avoid unnecessarily increasing the weight of the turbocharger and in addition protect turbochargers which are already employed in the field from fragments of a rotor striking through into the surroundings, it is already known from practice to equip a turbocharger with a casing that surrounds a turbine housing and/or a compressor housing and/or a bearing housing of the turbocharger radially outside as well as axially outside at least in sections. To date, such casings are always individually designed for the specific design embodiment of the turbocharger. This is disadvantageous.

### SUMMARY OF THE INVENTION

One aspect of the invention is based on creating a new type of casing of a turbocharger and a turbocharger having such a casing. According to one aspect of the invention, the casing comprises multiple casing modules, namely at least one temperature casing modulethat surrounds the turbine housing and/or the compressor housing and/or the bearing housing radially outside and axially outside, an inner burst protection casing module following the temperature casing module on the outside that surrounds the temperature casing module radially outside and axially outside, and at least one outer burst protection casing module following the inner burst protection casing module on the outside that surrounds the inner burst protection casing module exclusively radially outside. The invention proposes a casing consisting of multiple casing modules. The casing comprises at least the temperature casing module, the inner burst protection casing module and at least one outer burst protection casing module. Multiple outlet burst protection casing modules can also be present. By way of this modular construction of the casing the casing can, among other things, be employed on different assemblies of a turbocharger, and utilised on different designs of turbochargers, for example different sizes of turbochargers, in order to provide a corresponding containment protection.

A more important aspect of the modular design is the resulting advantage of being able to offer a solution to individual and different requirements in terms of containment safety in the turbocharger construction.

Preferentially, a flange connection casing module is arranged between the temperature casing module and the turbine housing or the compressor housing of the turbocharger, which flange connection casing module surrounds the turbine housing or the compressor housing radially outside and axially outside exclusively in the region of a connecting flange of turbine housing or compressor housing. The connecting flange of the turbine housing or compressor housing extends with an inflow opening or outflow opening through a recess in the flange connection casing module, wherein the temperature casing module and the burst protection casing modules also comprises recesses for the passage of the connecting flange of the turbine housing or of the connecting flange of the compressor housing. By way of this, a particularly advantageous connection of the casing to the turbine housing or compressor housing is possible.

Preferentially, the temperature casing module and the burst protection casing modules are composed of multiple circumferential segments connected to one another. By way of the circumferential segmentation of the individual casing modules, the casing can be simply adapted to different sizes of turbochargers. Furthermore, a simple mounting and dismounting of the casing is possible.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is a perspective view of a casing according to the invention for an assembly of a turbocharger;

FIG. 2 is an exploded representation of FIG. 1;

FIG. 3 is a cross section through FIG. 1;

FIG. 4 is a detail IV of FIG. 3;

FIG. 5 is a detail V of FIG. 3;

FIG. 6 is a detail VI of FIG. 3; and

FIG. 7 is a detail of FIG. 6 rotated by approximately 90°.

### DETAILED DESCRIPTION OF THE PRESENTLY PREFERRED EMBODIMENTS

The invention relates to a casing of a turbocharger and to a turbocharger having a casing.

The person skilled in the art addressed here is familiar with the fundamental construction of a turbocharger. Accordingly, a turbocharger comprises a turbine for expanding a first medium, in particular for expanding exhaust gas, and a compressor for compressing a second medium, in particular for compressing charge air, namely utilising the energy extracted in the turbine during the expansion of the first medium. The turbine comprises a turbine rotor and a turbine housing. The compressor comprises a compressor rotor and a compressor housing. The turbine rotor and the compressor rotor are coupled via a shaft mounted in a bearing housing of the turbocharger. The bearing housing is connected both to the turbine housing and also to the compressor housing.

During operation if the turbine rotor or the compressor rotor should break, fragments of the same can strike through the respective housing of the same, i.e. the turbine housing or the compressor housing, and enter the surroundings. This has to be avoided and it is known to equip a turbocharger with a casing that surrounds the turbine housing and/or the compressor housing and/or the bearing housing of the turbocharger.

Preferentially, a separate casing is employed in each case in the region of the turbine housing and of the compressor housing, which surrounds the respective assembly of the turbocharger to be encased radially outside and axially outside at least in sections.

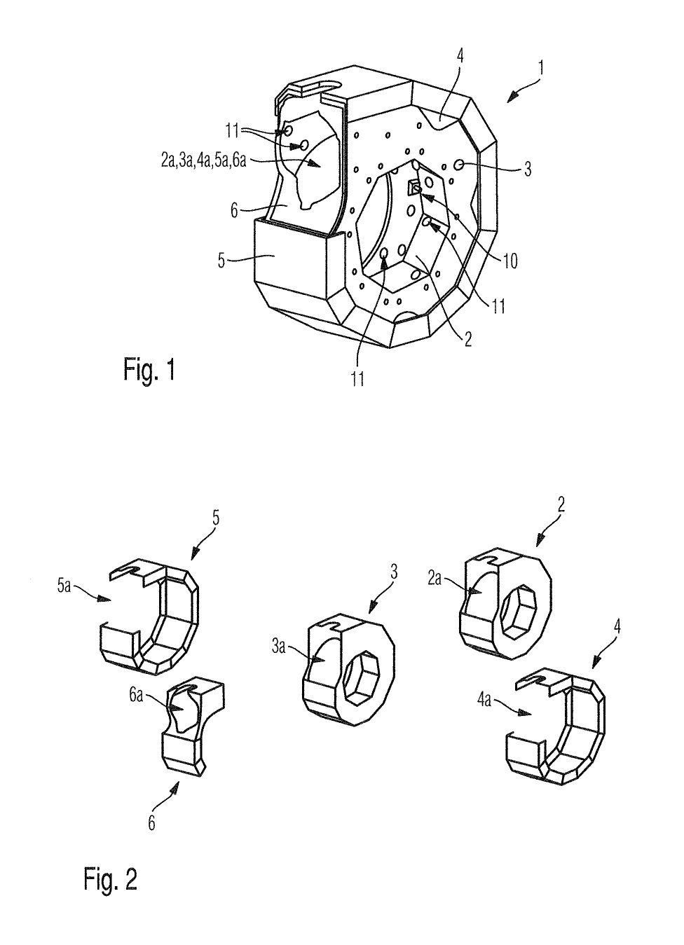

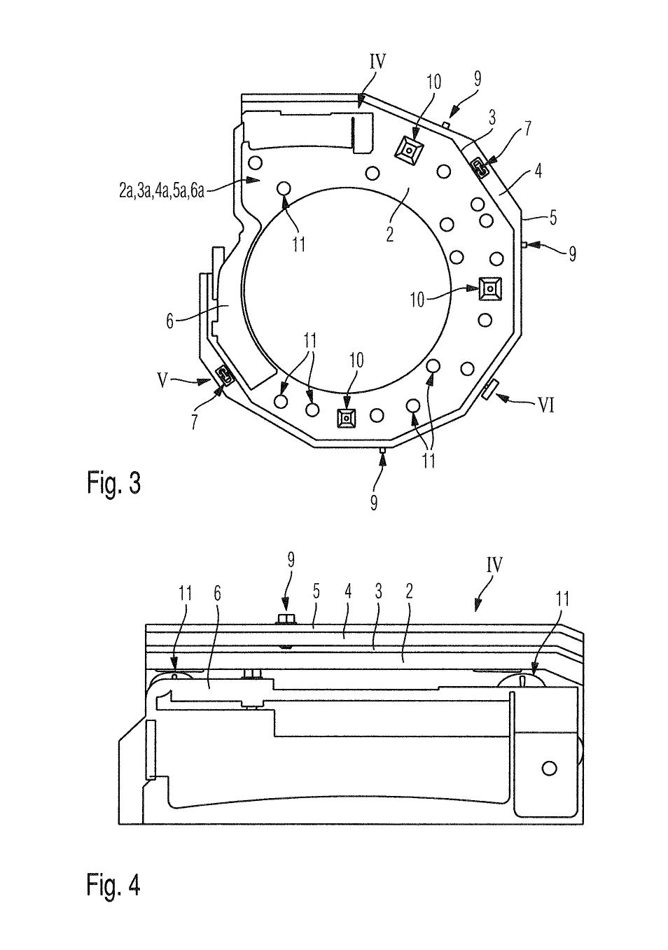

FIG. 1 shows a perspective view of a casing 1 according to one aspect of the invention for a turbocharger, which can be arranged about a turbine housing or about a compressor housing.

The casing 1 according to one aspect of the invention comprises multiple casing modules individually visible in an exploded representation of FIG. 1 in FIG. 2.

Accordingly, the casing 1 comprises a temperature casing module 2 that surrounds the turbine housing or the compressor housing radially outside and axially outside.

The temperature casing module 2 primarily serves for thermally insulating the assembly of the turbocharger to be encased, i.e. for thermally insulating the compressor housing or the turbine housing relative to the surroundings.

The casing 1, furthermore, comprises an inner burst protection casing module 3 following the temperature casing module 2 on the outside, which surrounds the temperature casing module 2 radially outside and axially outside. In addition, the casing 1 comprises at least one outer burst protection casing module 4, 5 following the inner burst protection casing module 3 on the outside, which exclusively surrounds the inner burst protection casing module 3 radially outside, but not axially.

In the shown exemplary embodiment, two outer burst protection casing modules 4, 5 are present, wherein a first outer burst protection casing module 4 directly follows the inner burst protection casing module 3 radially outside, and wherein a second outer burst protection casing module 5 directly follows the first outer burst protection casing module 4, so that the first outer burst protection casing module 4 is positioned sandwich-like between the inner burst protection casing module 3 and the second outer burst protection casing module 5.

Furthermore, FIG. 2 shows a flange connection casing module 6, which is arranged between the temperature casing module 2 and the turbine housing to be encased or the compressor housing to be encased. While the temperature casing module 2 and the burst protection casing modules 3, 4, 5 are formed circumferentially in the circumferential direction, the flange connection casing module 6 is, seen in the circumferential direction, not formed circumferentially but surrounds the turbine housing to be encased or the compressor housing to be encased radially outside and axially outside exclusively in the region of a connecting flange of turbine housing or compressor housing, which forms an inflow opening or outflow opening. This connecting flange of turbine housing or compressor housing can extend through a recess 6a in the flange connection casing module 6, wherein the temperature casing module 2 and the burst protection casing modules 3, 4, and 5 also have corresponding recesses 2a, 3a, 4a and 5a for the passage of the connecting flange of the turbine housing or the passage of the connecting flange of the compressor housing. In the mounted state (see FIG. 1), all recesses 2a, 3a, 4a, 5a and 6a are congruent, so that the connecting flange of turbine housing can extend through these recesses. By way of this, an optimal connection of the casing modules 2 to 6 to the assembly of the turbocharger to be encased is possible.

The casing modules 2, 3, 4, and 5 extending about in the circumferential direction are segmented in the circumferential direction and accordingly composed of multiple circumferential segments in each case, which are connected to one another.

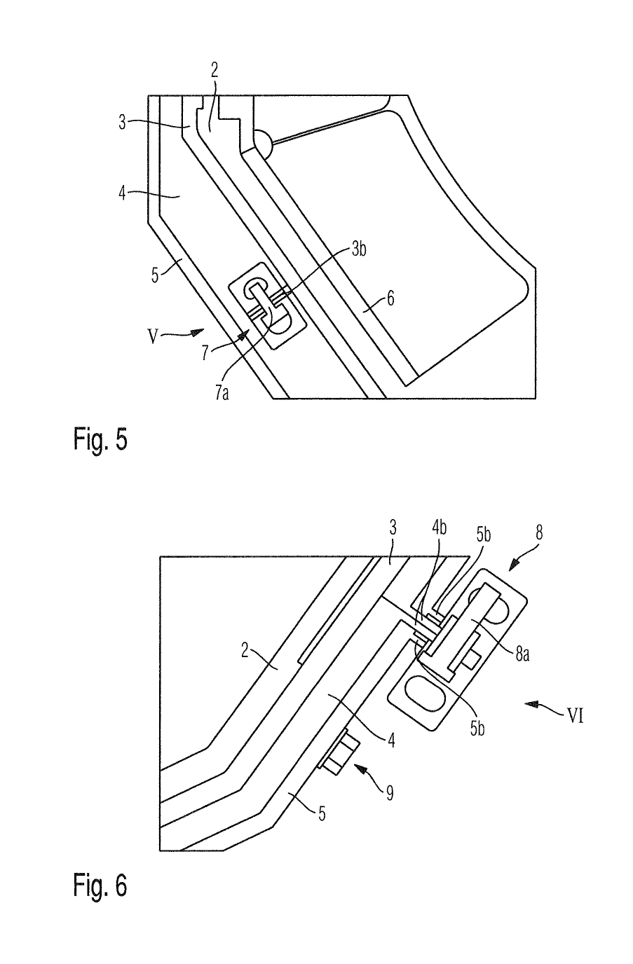

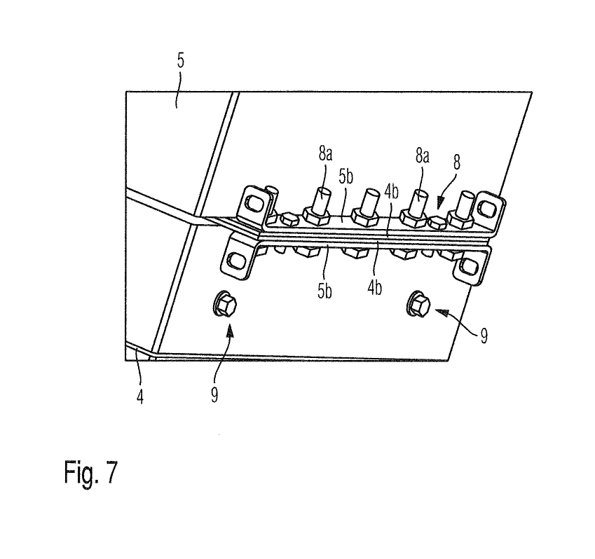

Accordingly, the inner burst protection casing module 3 is composed of multiple circumferential segments connected to one another via screw connections 7. FIG. 5 shows such a screw connection 7 between two adjoining circumferential segments of the inner burst protection casing module 3 in detail. Accordingly, three flanges 3b are formed on the adjoining ends of the adjacent circumferential segments of the inner burst protection casing module 3, which are angled in the radial direction and extend in the radial direction, wherein screws 7a of the screw connection 7 extend through these flanges 3b. These screws 7a extend perpendicularly through the flanges 3b, i.e. in the circumferential direction or tangential direction. By way of this it is avoided that screws 7a of the screw connections 7 are subjected to shearing forces and could fail as a consequence of such shearing forces.

The outer burst protection casing modules 4, 5 are also segmented in the circumferential direction, wherein the relevant circumferential segments are connected to one another via screw connections 8. FIG. 6 shows a detail of such a screw connection 8, via which adjoining circumferential segments of the first outer burst protection casing module 4 and adjoining circumferential segments of the second outer burst protection casing module 5 are connected to one another, namely jointly. Accordingly, FIG. 6 shows that flanges 4b extending in the radial direction are formed both on adjoining circumferential segments of the first outer burst protection casing module 4 and flanges 5b extending in the radial direction on adjoining circumferential segments of the second outer burst protection casing module 5.

Screws 8a of the screw connection 8 extend both through the flanges 4b and also through the flanges 5b, namely in the tangential direction or circumferential direction. Accordingly, these screws 8a are not subjected to shearing forces.

The temperature casing module 2 is also segmented in the circumferential direction, wherein adjacent circumferential segments are connected to one another. In the figures, connecting elements 11 are shown that connect the temperature casing module 2 to the inner burst protection casing module 3.

In addition to the mentioned screw connections 7 and 8, the individual casing modules 2, 3, 4, 5, and 6 can also be connected to one another by further screw connections 9, which extend in the radial direction through the individual casing modules.

On an inner surface facing a turbine housing to be encased or a compressor housing to be encased of a turbocharger, the temperature casing module 2 preferentially comprises spacers 10, via which a defined distance between the temperature casing module 2 and the turbine housing or compressor housing to be encased can be adjusted.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A casing of a turbocharger, configured radially and axially surround, at least in sections, a turbine housing and/or a compressor housing and/or a bearing housing of the turbocharger, the casing comprising:
at least one temperature casing module, which radially and axially surrounds, at least in sections, the turbine housing and/or the compressor housing and/or the bearing housing outside;
an inner burst protection casing module following on an outside of the temperature casing module, which radially and axially surrounds, at least in sections, the temperature casing module; and
at least one outer burst protection casing module following on an outside of the inner burst protection casing module, which exclusively radially surrounds, at least in sections, the inner burst protection casing module.

2. The casing according to claim 1, wherein the temperature casing module and the burst protection casing modules are circumferential in a circumferential direction.

3. The casing according to claim 1, further comprising:
a flange connection casing module arranged between the temperature casing module and the turbine housing or the compressor housing, which surrounds the turbine housing or the compressor housing radially outside and axially outside exclusively in a region of a connecting flange of turbine housing or compressor housing.

4. The casing according to claim 3, wherein the connecting flange of the turbine housing or the connecting flange of the compressor housing extends with an inflow opening or outflow opening through a recess in the flange connection casing module, and in that the temperature casing module and the burst protection casing modules which are circumferential in a circumferential direction, also comprise recesses for passage of the connecting flange of the turbine housing or of the connecting flange of the compressor housing.

5. The casing according to claim 1, wherein the temperature casing module and the burst protection casing modules comprise multiple circumferential segments connected to one another.

6. The casing according to claim 5, wherein the inner burst protection casing module comprises multiple circumferential segments connected to one another via screw connections.

7. The casing according to claim 6, wherein a first outer burst protection casing module following the inner burst protection casing module on the outside, which surrounds the inner burst protection casing module exclusively radially outside, comprises multiple circumferential segments connected to one another via screw connections.

8. The casing according to claim 7, wherein a second outer burst protection casing module following the first outer burst protection casing module on the outside, which surrounds the first outer burst protection casing module exclusively radially on the outside, is composed of multiple circumferential segments connected to one another via screw connections.

9. The casing according to claim 8, wherein circumferential segments of the first outer burst protection casing module and circumferential segments of the second outer burst protection casing modules are connected to one another via common screw connections.

10. The casing according to claim 9, wherein the screw connections are formed on flanges that extend in radial direction so that the screw connections extend in a circumferential direction or a tangential direction.

11. A turbocharger comprising:
a turbine for expanding a first medium;
a compressor for compressing a second medium utilising energy extracted in the turbine during expansion of the first medium;
a turbine housing of the turbine;
a compressor housing of the compressor;
a bearing housing arranged between the turbine housing and the compressor housing; and
a casing surrounding the turbine housing and/or the compressor housing and/or the bearing housing radially outside and axially outside at least in sections, wherein the casing comprises:
at least one temperature casing module, which radially and axially surrounds, at least in sections, the turbine housing and/or the compressor housing and/or the bearing housing outside;
an inner burst protection casing module following on an outside of the temperature casing module, which radially and axially surrounds, at least in sections, the temperature casing module; and
at least one outer burst protection casing module following on an outside of the inner burst protection casing module, which exclusively radially surrounds, at least in sections, the inner burst protection casing module.
